(19) United States
(12) Patent Application Publication
(10) Pub. No.: US 2026/0046664 A1
(43) Pub. Date: Feb. 12, 2026

(54) MINIMIZATION OF DRIVE TESTS CONFIGURATION SCOPE FOR DIFFERENT NETWORK TYPES

(71) Applicant: Telefonaktiebolaget LM Ericsson (publ), Stockholm (SE)

(72) Inventors: Tahmineh TORABIAN ESFAHANI, Sollentuna (SE); Ali PARICHEHREHTEROUJENI, Linköping (SE); Angelo CENTONZA, b (ES); Gautham NAYAK SEETANADI, Stockholm (SE); Marco BELLESCHI, Solna (SE)

(21) Appl. No.: 19/102,390

(22) PCT Filed: Aug. 8, 2023
(86) PCT No.: PCT/SE2023/050793

§ 371 Date: Feb. 8, 2025

Related U.S. Application Data
(60) Provisional application No. 63/396,155, filed on Aug. 8, 2022.

(51) Int. Cl. H04W 24/10; H04W 84/04

(52) U.S. Cl. CPC H04W 24/10; H04W 84/042

(57) ABSTRACT

A radio access network (“RAN”) node can determine a minimization of drive tests (“MDT”) configuration including an area scope associated with cells that are identified by at least one of: a public network integrated non-public network (“PNI-NPN”); a standalone non-public network (“SNPN”); and a public land mobile network (“PLMN”). The RAN node can configure a communication device served by a first cell in a first communication network with the MDT configuration to instruct the communication device to collect MDT measurements from a second cell in a second communications network.

### TECHNICAL FIELD

The present disclosure is related to wireless communication systems and more particularly to minimization of drive tests configuration scope for different network types.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Non-public Networks (“NPN”) are a feature which allows for a network to be deployed and/or managed by an entity other than a normal operator. A “normal operator” here is assumed to be an operator of one or more public land mobile networks (“PLMNs”). It should be noted that a PLMN also has an identifier which is called the PLMN identifier (“ID”), or sometimes just referred to as the “PLMN.”

### SUMMARY

According to some embodiments, a method of operating a radio access network (“RAN”) node is provided. The method includes determining a minimization of drive tests (“MDT”) configuration including an area scope that identifies at least one of: an identity of a public network integrated non-public network (“PNI-NPN”); an identity of a standalone non-public network (“SNPN”); and an identity of a public land mobile network (“PLMN”). The method can further include configuring a communication device served by a first cell in a first communication network with the MDT configuration to instruct the communication device to collect MDT measurements from a second cell in a second communications network.

According to other embodiments, a method of operating a core network (“CN”) node is provided. The method includes transmitting a minimization of drive tests (“MDT”) configuration to a radio access network (“RAN”) node. The MDT configuration includes an area scope that identifies at least of: an identity of a public network integrated non-public network (“PNI-NPN”); an identity of a standalone non-public network (“SNPN”); and an identity of a public land mobile network (“PLMN”).

According to other embodiments, a RAN node, CN node, communication device, computer program, computer program product, non-transitory computer-readable medium, system, or host is provided to perform one of the above methods.

Certain embodiments may provide one or more of the following technical advantages. In some embodiments, it is possible to report MDT measurements related information between SNPNs, PNI-NPNs and PLMNs which allows the networks to optimize the inter-network and intra-network coverage issues.

The addition of the NPN identifiers in the list of networks where an MDT configuration is valid is not obvious. The reason this is not obvious is that private networks are separate networks with respect to PLMNs. As an example, SNPNs are not supposed to be connected to PLMNs or PNI NPNs. Further, a UE according to current specifications is not allowed to perform mobility between an SNPN and other networks different from the SNPN.

Currently an MDT configuration can be applied to a UE only within a set of PLMNs that are equivalent with each other and that include the registered PLMN for the UE. Hence the extension of the area scope of an MDT configuration to NPNs is not obvious because it implies coordination and agreements between the NPN operator and the PLMN operator. The advantages however of this configuration are that, for UEs that are able to move amongst NPNs and PLMNs, an operator (a PLMN or NPN operator) can configure MDT measurements at the UE and, by receiving such measurements, it is able to have a consistent monitoring of several aspects concerning the PLMN and the NPN. In some examples, an operator can monitor coverage at NPN and PLMN and at coverage borders between the PLMN and NPN. This ensures that converge between the different networks is consistent and that mobility between different networks is not subject to failures due to poor coverage. In additional or alternative examples, an operator can monitor performance at radio and service level for UEs moving between PLMNs and NPNs. This allows the operator to optimize the steering of UEs towards coverage locations where specific services are best served, as well as to optimize service coverage there where performance is poor.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a signal flow diagram illustrating an example of successful operation of an initial context setup;

FIG. 3 is a signal flow diagram illustrating an example of successful operation of a handover resource allocation;

FIG. 4 is a signal flow diagram illustrating an example of successful operation of a trace start;

FIG. 5 is a table illustrating an example of a Trace Activation IE;

FIG. 6 is a table illustrating an example of a MDT Configuration IE;

FIG. 7 is a table illustrating an example of a MDT PLMN List IE;

FIG. 8 is a table illustrating an example of range bounds for the MDT PLMN list;

FIG. 9 is a table illustrating an example of a MDT Configuration-NR IE;

FIG. 10 is a table illustrating an example of range bounds for the MDT Configuration-NR;

FIG. 11 is a table illustrating an example of an area scope of neighbour cells IE;

FIG. 12 is a table illustrating an example of range bounds for the area scope of neighbour cells;

FIG. 13 is a schematic diagram illustrating an example of a communication device moving in and out of PN/NPN in accordance with some embodiments;

FIG. 14 is a schematic diagram illustrating an example of a communication device moving within a PN/NPN in accordance with some embodiments;

FIG. 15 is a table illustrating an example of a MDT Configuration-NR IE in accordance with some embodiments;

FIG. 16 is a table illustrating an example of range bounds for a MDT Configuration-NR in accordance with some embodiments;

FIG. 17 is a table illustrating an example of a MDT PLMN List IE in accordance with some embodiments;

FIG. 18 is a table illustrating an example of range bounds for the MDT PLMN List of FIG. 17 in accordance with some embodiments;

FIG. 19 is a table illustrating an example of Cell NID Information IE in accordance with some embodiments;

FIG. 20 is a table illustrating an example of a MDT NPN List IE in accordance with some embodiments;

FIG. 21 is a table illustrating an example of an area scope of neighbour cells IE in accordance with some embodiments;

FIG. 22 is a table illustrating another example of a MDT Configuration-NR IE in accordance with some embodiments;

FIG. 23 is a flow chart illustrating an example of operations performed by a network node in accordance with some embodiments; FIG. 24 is a block diagram of a communication system in accordance with some embodiments;

FIG. 25 is a block diagram of a user equipment in accordance with some embodiments;

FIG. 26 is a block diagram of a network node in accordance with some embodiments;

FIG. 27 is a block diagram of a host computer communicating with a user equipment in accordance with some embodiments;

FIG. 28 is a block diagram of a virtualization environment in accordance with some embodiments; and

FIG. 29 is a block diagram of a host computer communicating via a base station with a user equipment over a partially wireless connection in accordance with some embodiments.

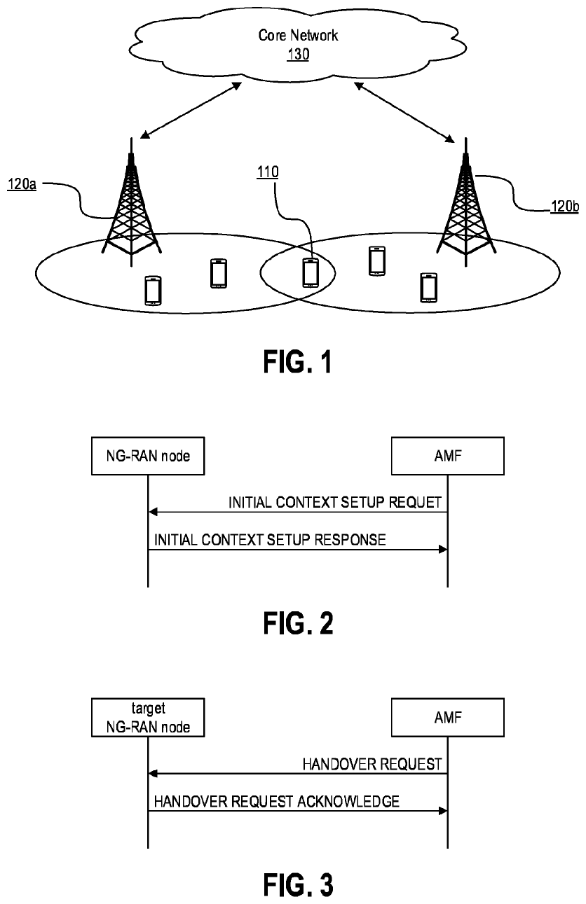

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There are two types of NPN networks, namely stand-alone NPNs (“SNPNs”) and public network integrated-NPNs (“PNI-NPNs”), which are described below.

A first network or network identifier (e.g., a PLMN) can be configured as equivalent to another network or network identifier. For example, the operator of one network has an agreement with another operator such that the users of these networks can consider the network equivalent. There is in current 3rd generations partnership project (“3GPP”) specifications no equivalent NPN networks, but it would be possible to introduce the concept of equivalent NPNs in the future. In the case of PNI-NPNs the concept of equivalent PLMN (“EPLMN”) is implicitly applied.

SNPN is a flavor of an NPN consisting of a non-PLMN entity. For example, it may be a private company who deploys a network, but that company is not/does not own a PLMN. It could for example be a company who owns factories and deploys networks in and around the factories for the sake of providing service to its employees and machines, etc.

An entity owning an SNPN does not necessarily own its own PLMN. An SNPN network has an identifier which includes a PLMN-identity and a network identity (“NID”). As described above, the entity who owns/manages the SNPN may not have its own PLMN Identity. But since the SNPN includes a PLMN, one way for the SNPN network owner to acquire an SNPN identifier is to make an agreement with a PLMN operator so that they can use the operator's PLMN. Another approach is that a “dummy” (e.g., “special,” “not normally used,” “invalid,”or similar) PLMN is used as part of the identity of the SNPN.

The PNI-NPN feature is another flavor of an NPN. Similar to SNPN, a PNI-NPN may be deployed to offer service to a certain set of users, for example to employees and machines of a company. The main difference between SNPN and PNI-NPN is that a PNI-NPN is integrated into a PLMN. A PNI-NPN may therefore be managed by the operator of the PLMN in which the PNI-NPN is integrated into.

The PNI-NPN has, instead of the NID-identifier which SNPNs use, an identifier called closed access group (“CAG”). A CAG is associated to each cell forming the PNI-NPN. The UEs of the employees, machines, etc. of the company who should be given access to the PNI-NPN are configured with the relevant CAG. Other UEs does not have access to the PNI-NPN and not configured to use the CAG. In the general case, both the UE and the network is performing a check when determining if the UE can connect to a PNI-NPN by looking at if the UE is configured with the CAG and only if that is the case, the UE is given access to the PNI-NPN.

A purpose of the Initial Context Setup procedure is to establish the necessary overall initial UE context at the NG-RAN node, when required, including protocol data unit (“PDU”) session context, the Security Key, Mobility Restriction List, UE Radio Capability and UE Security Capabilities, etc. The access and mobility management function (“AMF”) may initiate the Initial Context Setup procedure if a UE-associated logical NG-connection exists for the UE or if the AMF has received the RAN UE NGAP ID IE in an INITIAL UE MESSAGE or if the NG-RAN node has already initiated a UE-associated logical NG-connection by sending an INITIAL UE MESSAGE via another NG interface instance. The procedure can use UE-associated signaling as illustrated in FIG. 2.

For signaling only connections and if the UE Context Request IE is not received in the Initial UE Message, the AMF may be configured to trigger the procedure for all NAS procedures or on a per NAS procedure basis depending on operator's configuration.

In case of the establishment of a PDU session the 5GC shall be prepared to receive user data before the INITIAL CONTEXT SETUP RESPONSE message has been received by the AMF. If no UE-associated logical NG-connection exists, the UE-associated logical NG-connection shall be established at reception of the INITIAL CONTEXT SETUP REQUEST message.

The INITIAL CONTEXT SETUP REQUEST message shall contain the Index to RAT/Frequency Selection Priority IE, if available in the AMF.

If the NAS-PDU IE is included in the INITIAL CONTEXT SETUP REQUEST message, the NG-RAN node shall pass it transparently towards the UE.

If the Masked IMEISV IE is contained in the INITIAL CONTEXT SETUP REQUEST message the target NG-RAN node shall, if supported, use it to determine the characteristics of the UE for subsequent handling.

Upon receipt of the INITIAL CONTEXT SETUP REQUEST message the NG-RAN node shall: attempt to execute the requested PDU session configuration; store the received UE Aggregate Maximum Bit Rate in the UE context, and use the received UE Aggregate Maximum Bit Rate for Non-GBR QoS flows for the concerned UE as specified in TS 23.501; store the received Mobility Restriction List in the UE context; store the received UE Radio Capability in the UE context; store the received Index to RAT/Frequency Selection Priority in the UE context and use it as defined in TS 23.501; store the received UE Security Capabilities in the UE context; store the received Security Key in the UE context and, if the NG-RAN node is required to activate security for the UE, take this security key into use; if supported, store the received SRVCC Operation Possible in the UE context and use it as defined in TS 23.216; store the received NR V2X Services Authorization information, if supported, in the UE context; store the received LTE V2X Services Authorization information, if supported, in the UE context; store the received NR UE Sidelink Aggregate Maximum Bit Rate, if supported, in the UE context, and use it for the concerned UE's sidelink communication in network scheduled mode for NR V2X services; store the received LTE UE Sidelink Aggregate Maximum Bit Rate, if supported, in the UE context, and use it for the concerned UE's sidelink communication in network scheduled mode for LTE V2X services; store the received PC5 QoS Parameters, if supported, in the UE context and use it as defined in TS 23.287; store the received Management Based MDT PLMN List information, if supported, in the UE context; if supported, store the received IAB Authorization information in the UE context; store the received 5G ProSe Authorization information in the UE context, if supported, and use it for the concerned UE's sidelink communication in network scheduled mode for 5G ProSe services; store the 5G ProSe UE PC5 Aggregate Maximum Bit Rate in the UE context, if supported, and use it for the concerned UE's sidelink communication in network scheduled mode for 5G ProSe services; and store the 5G ProSe PC5 QOS Parameters, if supported, in the UE context and use it as defined in TS 23.304.

If the Mobility Restriction List IE is not contained in the INITIAL CONTEXT SETUP REQUEST message, the NG-RAN node shall consider that no roaming and no access restriction apply to the UE. The NG-RAN node shall also consider that no roaming and no access restriction apply to the UE when one of the QoS flows includes a particular ARP value (TS 23.501).

If the Trace Activation IE is included in the INITIAL CONTEXT SETUP REQUEST message the NG-RAN node shall, if supported, initiate the requested trace function as described in TS 32.422. In particular, the NG-RAN node shall, if supported: if the Trace Activation IE includes the MDT Activation IE set to “Immediate MDT and Trace”, initiate the requested trace session and MDT session as described in TS 32.422; if the Trace Activation IE includes the MDT Activation IE set to “Immediate MDT Only”, “Logged MDT only”, initiate the requested MDT session as described in TS 32.422 and the NG-RAN node shall ignore the Interfaces To Trace IE and the Trace Depth IE; if the Trace Activation IE includes the MDT Location Information IE within the MDT Configuration IE, store this information and take it into account in the requested MDT session; if the Trace Activation IE includes the Signalling Based MDT PLMN List IE within the MDT Configuration IE, the NG-RAN node may use it to propagate the MDT Configuration as described in TS 37.320; if the Trace Activation IE includes the Bluetooth Measurement Configuration IE within the MDT Configuration IE, take it into account for MDT Configuration as described in TS 37.320; if the Trace Activation IE includes the WLAN Measurement Configuration IE within the MDT Configuration IE, take it into account for MDT Configuration as described in TS 37.320; if the Trace Activation IE includes the Sensor Measurement Configuration IE within the MDT Configuration IE, take it into account for MDT Configuration as described in TS 37.320; if the Trace Activation IE includes the MDT Configuration IE and if the NG-RAN node is a gNB at least the MDT Configuration-NR IE shall be present, while if the NG-RAN node is an ng-eNB at least the MDT Configuration-EUTRA IE shall be present.

Handover Resource Allocation is described below.

A purpose of the Handover Resource Allocation procedure is to reserve resources at the target NG-RAN node for the handover of a UE. The procedure can UE-associated signaling as illustrated in FIG. 3.

The AMF initiates the procedure by sending the HANDOVER REQUEST message to the target NG-RAN node.

If the Trace Activation IE is included in the HANDOVER REQUEST message the target NG-RAN node shall, if supported, initiate the requested trace function as described in TS 32.422. In particular, the NG-RAN node shall, if supported: if the Trace Activation IE includes the MDT Activation IE set to “Immediate MDT and Trace”, initiate the requested trace session and MDT session as described in TS 32.422; if the Trace Activation IE includes the MDT Activation IE set to “Immediate MDT Only”, “Logged MDT only”, initiate the requested MDT session as described in TS 32.422 and the target NG-RAN node shall ignore the Interfaces To Trace IE and the Trace Depth IE; if the Trace Activation IE includes the MDT Location Information IE within the MDT Configuration IE, store this information and take it into account in the requested MDT session; if the Trace Activation IE includes the Signalling Based MDT PLMN List IE within the MDT Configuration IE, the NG-RAN node may use it to propagate the MDT Configuration as described in TS 37.320; if the Trace Activation IE includes the Bluetooth Measurement Configuration IE within the MDT Configuration IE, take it into account for MDT Configuration as described in TS 37.320; if the Trace Activation IE includes the WLAN Measurement Configuration IE within the MDT Configuration IE, take it into account for MDT Configuration as described in TS 37.320; if the Trace Activation IE includes the Sensor Measurement Configuration IE within the MDT Configuration IE, take it into account for MDT Configuration as described in TS 37.320; if the Trace Activation IE includes the MDT Configuration IE and if the NG-RAN node is a gNB at least the MDT Configuration-NR IE shall be present, while if the NG-RAN node is an ng-eNB at least the MDT Configuration-EUTRA IE shall be present.

If the Location Reporting Request Type IE is included in the HANDOVER REQUEST message, the target NG-RAN node should perform the requested location reporting functionality for the UE as described in subclause 8.12.

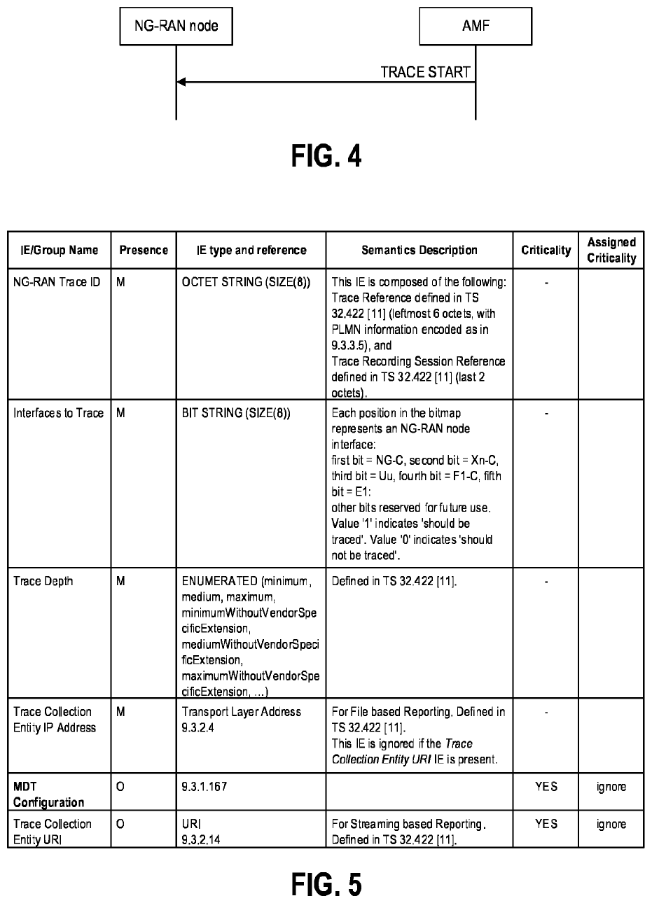

A purpose of the Trace Start procedure is to allow the AMF to request the NG-RAN node to initiate a trace session for a UE. The procedure uses UE-associated signaling as illustrated in FIG. 4. If no UE-associated logical NG-connection exists, the UE-associated logical NG-connection shall be established as part of the procedure.

The AMF initiates the procedure by sending a TRACE START message. Upon reception of the TRACE START message, the NG-RAN node shall initiate the requested trace session as described in TS 32.422.

If the Trace Activation IE is included in the TRACE START message which includes the MDT Activation IE set to “Immediate MDT and Trace”, the NG-RAN node shall, if supported, initiate the requested trace session and MDT session as described in TS32.422.

If the Trace Activation IE is included in the TRACE START message which includes the MDT Activation IE set to “Immediate MDT Only”, “Logged MDT only”, the NG-RAN node shall, if supported, initiate the requested MDT session as described in TS 32.422 and the NG-RAN node shall ignore the Interfaces To Trace IE and the Trace Depth IE.

If the Trace Activation IE includes the MDT Location Information IE within the MDT Configuration IE, the NG-RAN node shall, if supported, store this information and take it into account in the requested MDT session.

If the Trace Activation IE is included in the TRACE START message which includes the MDT Activation IE set to “Immediate MDT Only”, “Logged MDT only” and if the Signalling Based MDT PLMN List IE is included in the MDT Configuration IE, the NG-RAN node may use it to propagate the MDT Configuration as described in TS 37.320.

If the Trace Activation IE includes the Bluetooth Measurement Configuration IE within the MDT Configuration IE, the NG-RAN node shall, if supported, take it into account for MDT Configuration as described in TS 37.320.

If the Trace Activation IE includes the WLAN Measurement Configuration IE within the MDT Configuration IE, the NG-RAN node shall, if supported, take it into account for MDT Configuration as described in TS 37.320.

If the Trace Activation IE includes the Sensor Measurement Configuration IE within the MDT Configuration IE, the NG-RAN node shall, if supported, take it into account for MDT Configuration as described in TS 37.320.

If the Trace Activation IE includes the MDT Configuration IE and if the NG-RAN node is a gNB at least the MDT Configuration-NR IE shall be present, while if the NG-RAN node is an ng-eNB at least the MDT Configuration-EUTRA IE shall be present.

FIG. 5 illustrates an example of a Trace Activation IE, which defines parameters related to a trace session activation.

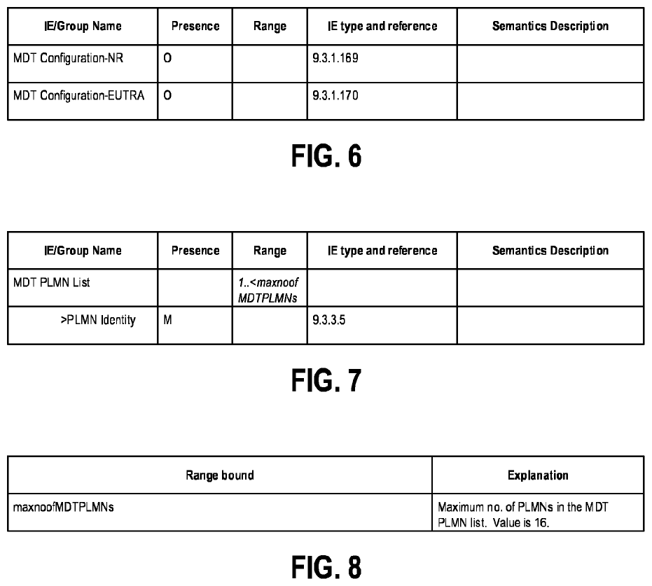

FIG. 6 illustrates an example of a MDT configuration IE that defines the MDT configuration parameters.

FIG. 7 illustrates an example of a MDT PLMN List IE that provides a list of PLMN allowed for MDT. FIG. 8 illustrates an example of range bounds of the MDT PLMN List IE.

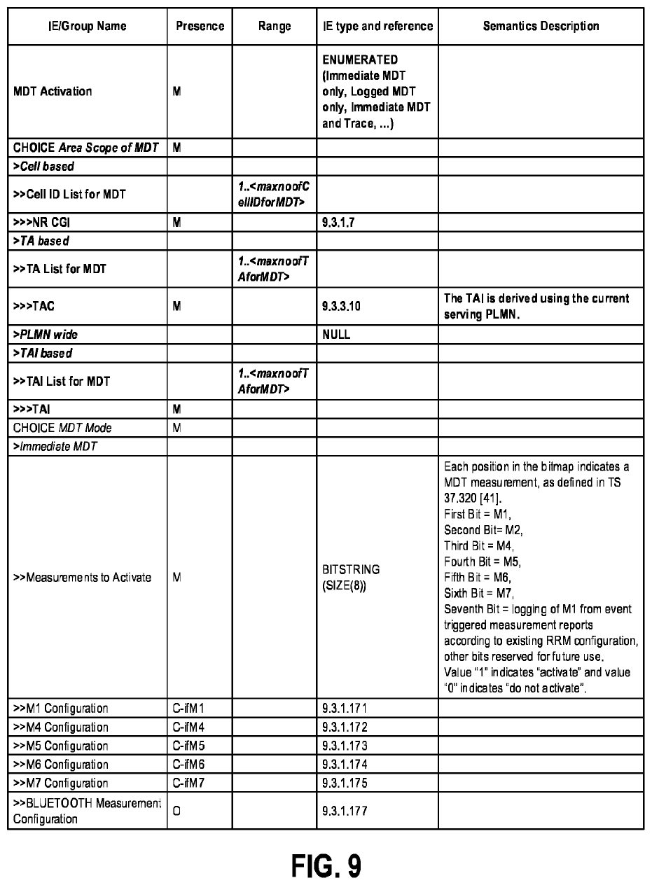

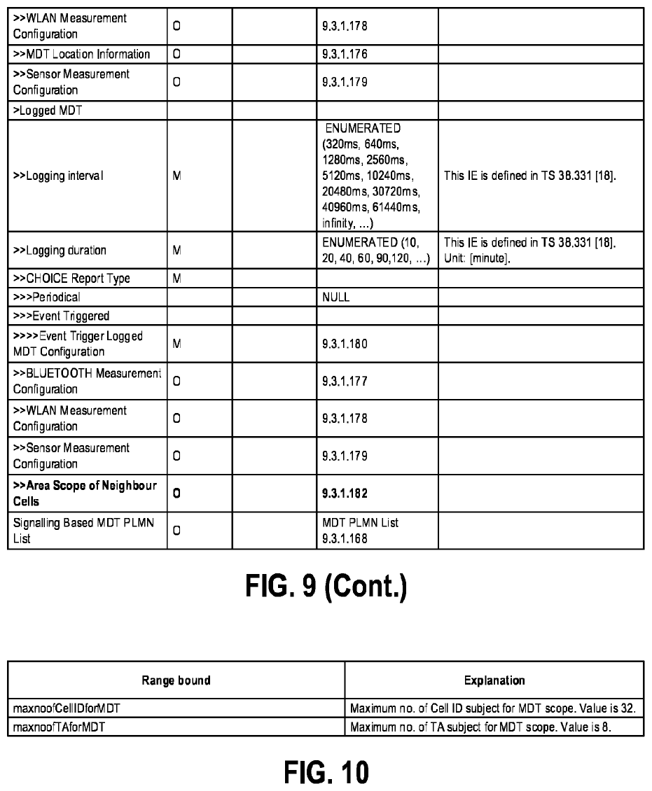

FIG. 9 illustrates an example of a MDT Configuration-NR IE that defines the MDT configuration parameters of NR.

FIG. 10 illustrates an example of range bounds of the MDT Configuration-NR IE.

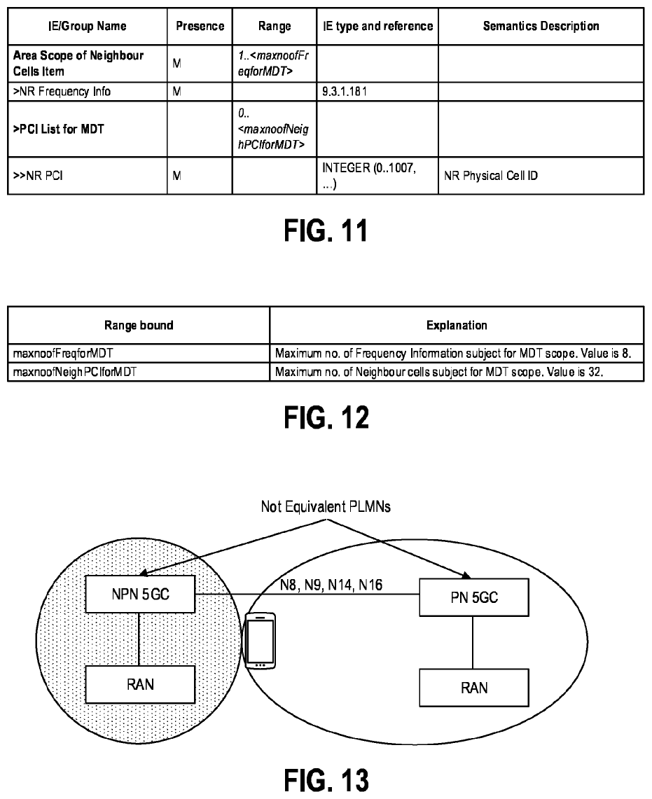

FIG. 11 illustrates an example of an area scope of neighbour cells IE that define the area scope of neighbour cells for logged MDT. FIG. 12 illustrates an example of range bounds of the area scope of neighbor cells IE.

There currently exist certain challenges. In some examples, a problem has been identified with a flexibility of an existing solution in the MDT Configuration collection with respect to the scope of MDT measurements that only supports MDT Configuration collection in public network.

Moreover, a UE may have access and subscription to several networks or different network types (e.g., SNPN, PNI-NPNs, and PLMNs). Also, a UE can perform registration on a private network (e.g., SNPN) if the UE is capable of services which require specific subscriptions for registration. In general, a UE is successfully registered on a private network (e.g., an SNPN) if (1) the UE has found a suitable cell of the SNPN to camp on; and (2) a registration from the UE has been accepted in the registration area of the cell on which the UE is camped. Today, support for MDT configuration for private network does not exist in technical specification. This implies that the RAN is not able to know whether MDT measurements collected by a UE can be also collected on NPN networks. This can create a number of problems such as: (1) a lack of MDT measurement continuity when the UE moves from a PLMN to an NPN and vice versa; and (2) a lack of MDT measurements collection when a UE attached and moves to RRC_Connected within an NPN.

The issues above also imply that a network operator of a private network is not able to collect MDT related information via UEs that connect/move-to other networks. Such UEs may provide measurements on the operator's PLMN cells, seen from UEs served by neighbour NPN cells. Such measurements are beneficial because they allow to optimize coverage and performance within the PLMN.

Certain aspects of the disclosure and their embodiments may provide solutions to these or other challenges. In some embodiments, a first network node (e.g., AMF/OAM of a network) can send a MDT configuration to a RAN node, the MDT configuration includes area scope that identifies at least one of the following networks. The information includes one or more of the following: (1) an identity of a PNI NPN; (2) identities associated to a SNPN; (3) the identities can include at least a list of NPN PLMN(s), CAG ID(s), and NID ID(s); and (4) identities associated to a public network (PLMN).

In some examples, where the MDT configuration produced by the first network node includes an area scope that spans across PN and NPN networks, the first network node (e.g., AMF/OAM) performs operations.

In some examples, the operations include configuring respective MDT measurements configuration for the second network node operating in NPN i.e., PNI-NPN and/or SNPN for specific UEs that are registered in the first network (NPN) and moving between first and second network coverage.

In additional or alternative examples, the operations include configuring respective MDT measurements configuration for the third network node operating in other PLMNs associated to a PN, for specific UEs that are registered in the second network (PN) and moving between first and second network coverage.

In additional or alternative examples, the operations include configuring respective MDT measurements configuration for the second network node operating in NPN i.e., PNI-NPN and/or SNPN for specific UEs that are registered in the second network (PN) and moving between first and second network coverage.

In additional or alternative examples, the operations include configuring respective MDT measurements configuration for the third network node operating in other PLMNs associated to a PN, for specific UEs that are registered in the first network (NPN) and moving between first and second network coverage.

Embodiments for UEs in DC scenarios are described below.

In some examples, the operations include configuring respective MDT measurements for the second network node operating in PNI-NPI or SNPN as secondary node (SN) and the third network node as master node (MN) as dual connectivity configuration, for specific UEs that are registered in both (the first and second) networks.

In additional or alternative examples, the operations include configuring respective MDT measurements for the third network node operating in other PLMNs associated to PN as master node MN and the second network node as SN as dual connectivity configuration, for specific UEs that are registered in both (the first and second) networks.

In some embodiments, area scope for MDT configuration is extended by including support for different network types. NPN identifiers associated can be included in area scope for a MDT configuration.

Herein, the terms non-public networks/private networks (“NPN”) and standalone NPN (“SNPN”)/public network integrated-NPN (“PNI-NPN”) nodes has been used interchangeably. In some examples, PNI-NPN network herein covers the scenario when a cell advertises a public land mobile network (“PLMN”)+closed access group (“CAG”) in NPN-Identity in system information block 1 (“SIB1”).

SNPN network herein covers the scenario when a cell advertises a PLMN +network identity (“NID”) in NPN-Identity in SIB1.

For management-based minimization of drive test (“MDT”), the core network (“CN”) indicates to the radio access network (“RAN”) nodes whether MDT is allowed to be configured by the RAN node for every connected user equipment (“UE”) (also referred to herein as a communication device) via providing a Management Based MDT PLMN List for each UE.

For signaling based MDT, the CN indicates to the RAN nodes whether MDT is allowed to be configured by the RAN node for every connected UE via providing a signaling Based MDT PLMN List for each UE In existing technical specifications, only the signaling based MDT PLMN List is propagated during intra-PLMN handover, intra-PLMN UE context retrieval.

In some embodiments, the list of network identities including PN identities and/or NPN identities and constituting the area scope within which an MDT configuration (management based or signaling based) can be configured at the UE, is signaled from source to target during intra PLMN and Inter PLMN mobility, Intra and inter system mobility (e.g. for UEs moving from a PLMN to an SNPN), and during intra network UE context retrieval.

In additional or alternative embodiments, operations are performed by the first network node (e.g., access and mobility management function (“AMF”)/operations, administration, and maintenance (“OAM”) of a network), sending an MDT configuration to a RAN node, the MDT configuration includes area scope that identifies at least one network.

The information includes one or more of the following: (1) Identity of a PNI NPN (Public Network integrated NPN); (2) Identities associated to a SNPN (Standalone NPN); (3) Identities can include at least a list of NPN PLMN(s), CAG ID(s), and NID ID(s); and (4) Identities associated to a public network (PLMN).

Cross network type Configuration are described below. In some embodiments, operations performed at the first network node operating in one network to configure respective measurements and reports for the second network node (e.g., a private network/NPN for the UEs that are only registered in the first network).

FIG. 13 illustrates an example of a UE moving in and out of a second network (shaded portion).

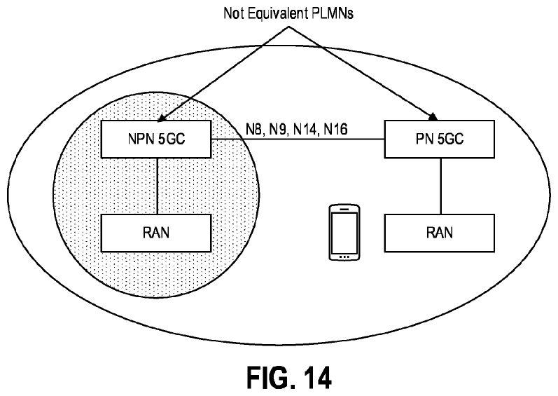

FIG. 14 illustrates an example of a UE moving within a second network (shaded).

In some embodiments, a first node signals an MDT Configuration for either signaling based or management based MDT to allow a RAN node to configure at least one UE served by a cell in PNI-NPN with respective MDT measurement configurations to be collected also from the cell belonging to the second network node in public network.

In additional or alternative embodiments, a first node signals an MDT Configuration for either signaling based or management based MDT to allow a RAN node configuring at least one UE served by a cell in PNI-NPN with respective MDT measurement configurations to be collected also from cells belonging to the second network node in SNPN.

In additional or alternative embodiments, a first node signals an MDT Configuration for either signaling based or management-based MDT to allow a RAN node configuring at least one UE served by a cell in PNI-NPN with respective MDT measurement configurations to be collected also from cells belonging to the second network node in other PNI-NPN.

In additional or alternative embodiments, a first node signals an MDT Configuration for either signaling based or management-based MDT to allow a RAN node configuring at least one UE served by a cell in SNPN with respective MDT measurement configurations to be collected either exclusively by or additionally from cells belonging to the second network node in PNI-NPN.

In additional or alternative embodiments, a first node signals an MDT Configuration for either signaling based or management-based MDT to allow a RAN node configuring at least one UE served by a cell in SNPN with respective MDT measurement configurations to be collected either exclusively by or additionally from cells belonging to the second network node in other SNPN.

In additional or alternative embodiments, a first node signals an MDT Configuration for either signaling based or management-based MDT to allow a RAN node configuring at least one UE served by a cell in SNPN with respective MDT measurement configurations to be collected either exclusively by or additionally from cells belonging to the second network node in public network.

In additional or alternative embodiments, a first node signals an MDT Configuration for either signaling based or management-based MDT to allow a RAN node configuring at least one UE served by a cell in public network with respective MDT measurement configurations to be collected either exclusively by or additionally from cells belonging to the second network node in PNI-NPN.

In additional or alternative embodiments, a first node signals an MDT Configuration for either signaling based or management-based MDT to allow a RAN node configuring at least one UE served by a cell in public network with respective MDT measurement configurations to be collected either exclusively by or additionally from the cells belonging to the second network node in SNPN.

In additional or alternative embodiments, the first network node may be one of the following: a CN node in Public Network; an OAM in Public Network; a CN node in SNPN; and an OAM in SNPN.

In additional or alternative embodiments, if the MDT configuration is for immediate MDT, the UE collects MDT measurements and immediately reports it to the serving network. The serving network many forward the measurements to the system that analyses the measurements (e.g., the OAM system).

In additional or alternative embodiments, if the MDT configuration is for logged MDT, the UE logs MDT measurements and reports them to the serving network at the time of log reporting. The serving network many forward the measurements to the system that analyses the measurements (e.g., the OAM system).

In additional or alternative embodiments, the entity that receives the MDT measurements collected by the UE and signaled by the serving RAN may be the OAM of the operator managing the public network or the OAM of the operator managing the private network.

An implementation example is described below.

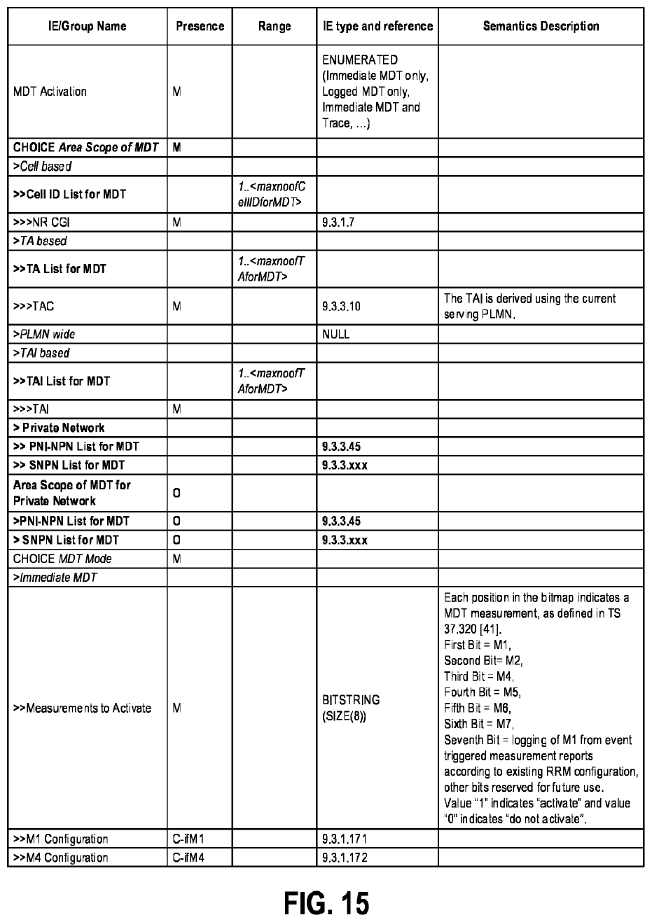

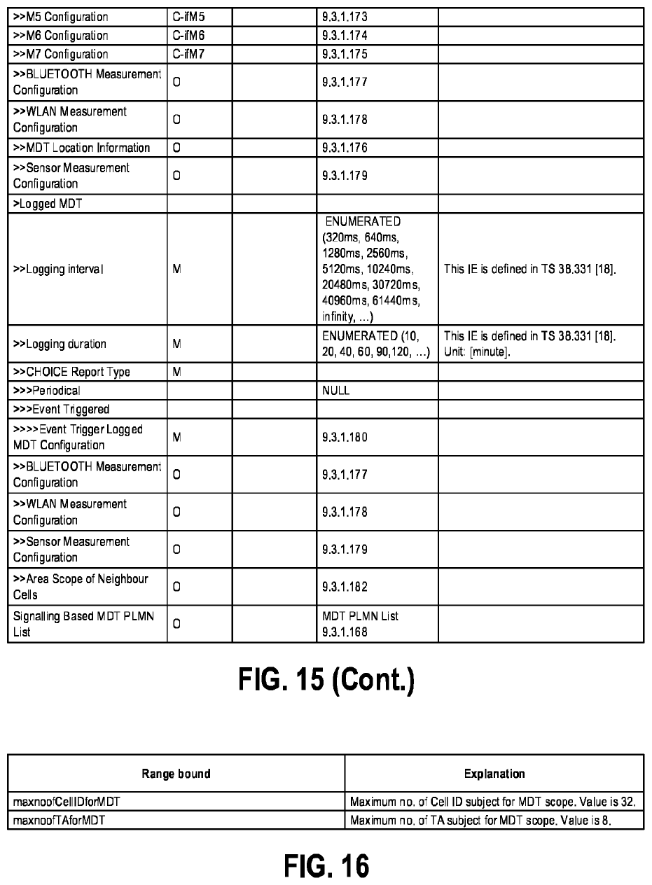

In some embodiments, the CN requests the Network node to configure a specific UE with the MDT measurements related information if the serving cell associated to private network (e.g., SNPN) and PNI-NPN is part of MDT configuration-NR. An implementation example is given in FIGS. 15-16.

FIG. 15 illustrates an example of a MDT Configuration-NR IE that defines the MDT configuration parameters of NR.

FIG. 16 illustrates an example of range bounds for MDT Configuration-NR.

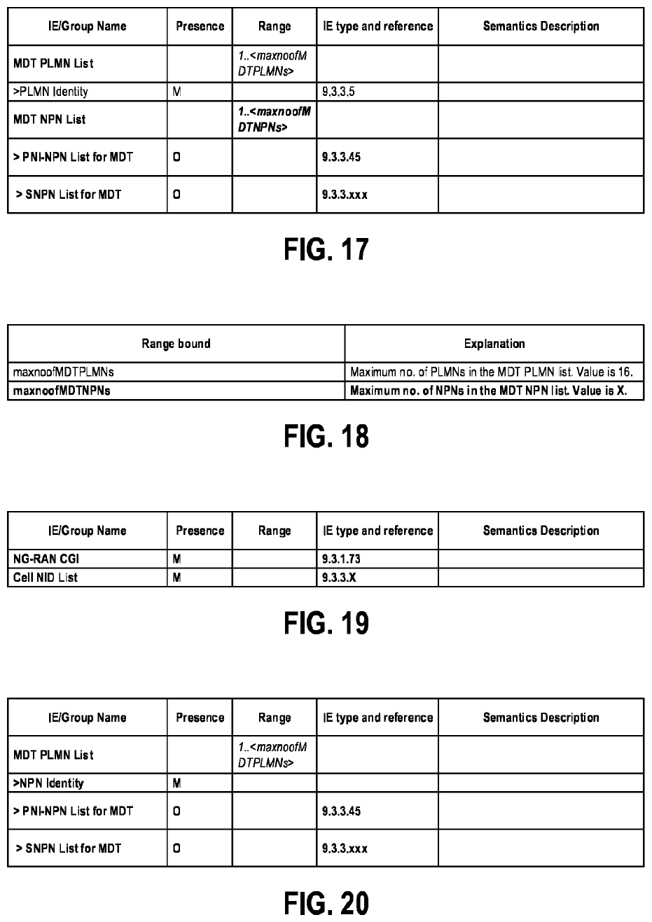

In additional or alternative embodiments, the CN requests the Network node to configure a specific UE with the MDT measurements related information: PLMN and NPN list for signalling based MDT. An implementation example is given in FIGS. 17-18.

FIG. 17 illustrates an example of a MDT PLMN List IE that provides a list of PLMN identities allowed for MDT.

FIG. 18 illustrates an example of range bounds for a MDT PLMN List.

In additional or alternative embodiments, for signalling based MDT, FIGS. 19-20 illustrate implementation examples to be added optionally to the following messages: INITIAL CONTEXT SETUP REQUEST; HANDOVER REQUEST; or PATH SWITCH REQUEST ACKNOWLEDGE.

FIG. 19 illustrates an example of a MDT NPN List IE that provides a list of NPN identities allowed for MDT.

FIG. 20 illustrates an example of range bounds for a MDT NPN List.

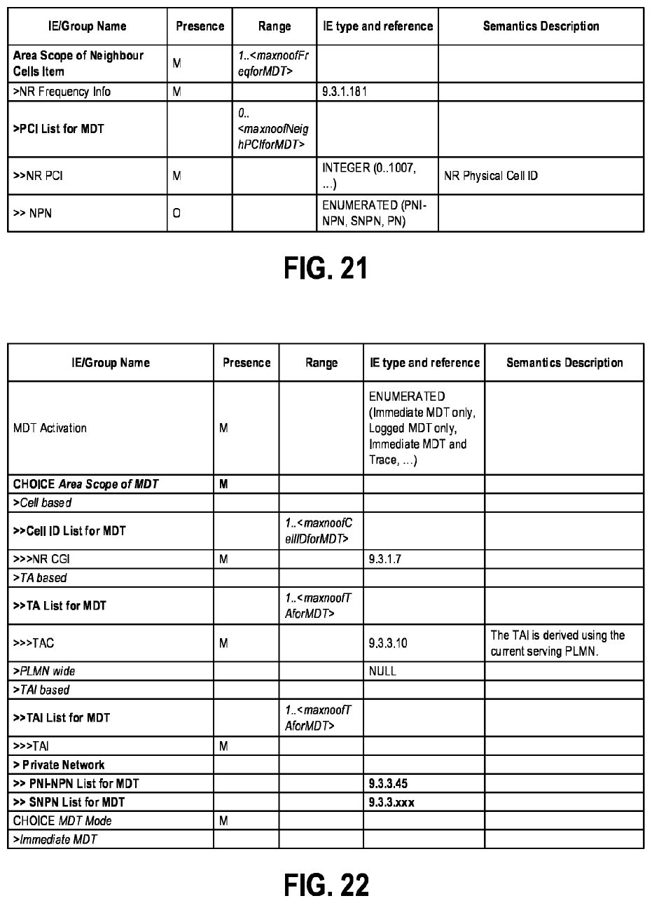

In additional or alternative embodiments, an alternate implementation for signalling based MDT is to add a flag indicating the neighbour NR physical Cell ID belongs to NPN network as illustrated in FIG. 21.

Embodiments within NPN configuration are described below.

In some embodiments, operations are performed at the first network node operating in a private network/NPN to configure respective MDT measurements for the second network node that is in the same network as the first network node.

In additional or alternative embodiments, CN in SNPN signals trace-based messages for specific UE to allow a RAN node configuring at least one UE served by a cell in SNPN with respective MDT measurement configurations for the cell belonging to the same SNPN.

In additional or alternative embodiments, CN in PNI-NPN signals trace-based messages for specific UE to allow a RAN node configuring at least one UE served by a cell PNI-NPN with respective MDT measurement configurations for the cell belonging to the same PNI-NPN.

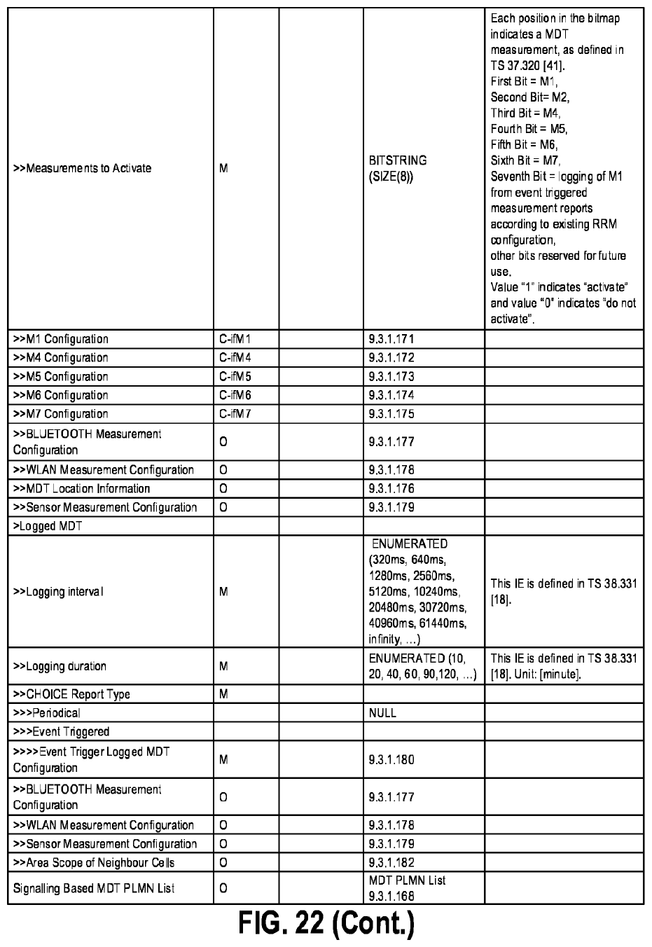

In some examples, CN requests the Network node to configure a specific UE with the MDT measurements related information: If the serving cell (last suitable cell in this context) associated to private network i.e., SNPN and PNI-NPN is part of MDT configuration-NR. An implementation example is illustrated in FIG. 22.

FIG. 22 illustrates an additional or alternative example of a MDT Configuration-NR IE that defines the MDT configuration parameters of NR.

Dual network connectivity configuration is described below.

In some embodiments, operations performed in dual connectivity (“DC”) operation operating at the first network as master node (“MN”) and at the second network as secondary node (“SN”) for specific UEs. UEs are performing registration in both (the first and second) networks. In MR-DC scenarios: (a) a cell operating in the public network as MN and a cell operating in PNI-NPN as SN and vice versa; (b) a cell operating in the public network as MN and a cell operating in SNPN as SN and vice versa; and (c) a cell operating in the SNPN as MN and a cell operating in PNI-NPN as SN and vice versa.

In additional or alternative embodiments, the first network provides MDT configuration for both MN and SN via MN and then MN forwards the MDT configuration to SN.

In additional or alternative embodiments, the second network provides MDT configuration for both MN and SN via SN and then SN forwards the MDT configuration to MN.

In additional or alternative embodiments, the second network forwards the associated MDT configuration to the first network requesting first network for MDT related configuration.

In additional or alternative embodiments, upon reception of the measurement results by the first network, the first network forwards the associated measurement results to the second network (If the corresponding measurement results to each network are not reported separately).

In additional or alternative embodiments, upon reception of the measurement results by the second network, the first network forwards the associated measurement results to the first network (If the corresponding measurement results to each network are not reported separately).

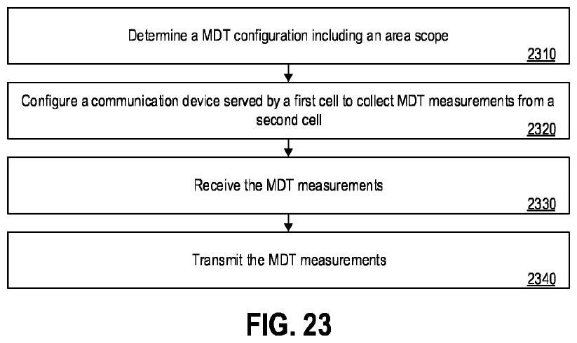

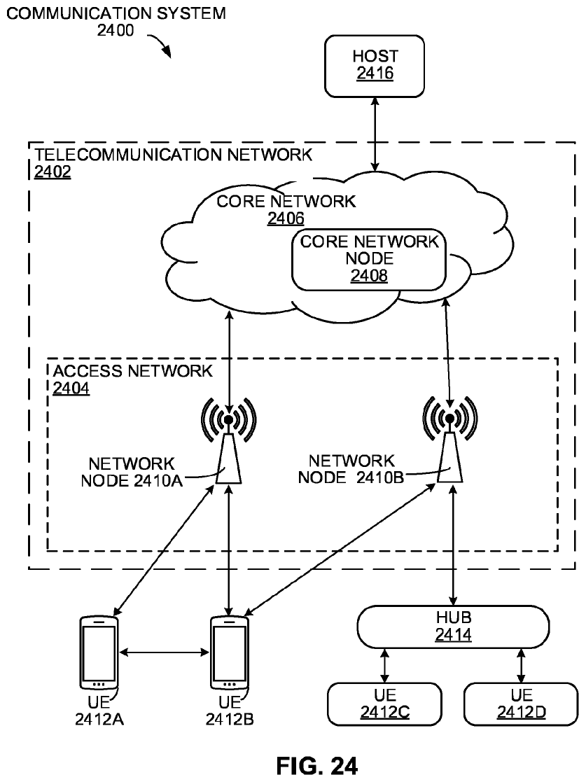

In the description that follows, while the network node may be any of Hub 2414, network node 2410A-B, core network node 2408, network node 2600, virtualization hardware 2804, virtual machines 2808A, 2808B, or network node 2904, the network node 2600 shall be used to describe the functionality of the operations of the network node. Operations of the network node 2600 (implemented using the structure of the block diagram of FIG. 26) will now be discussed with reference to the flow chart of FIG. 23 according to some embodiments of inventive concepts. For example, modules may be stored in memory 2604 of FIG. 26, and these modules may provide instructions so that when the instructions of a module are executed by respective network node processing circuitry 2602, processing circuitry 2602 performs respective operations of the flow charts.

FIG. 23 illustrates operations performed by a network node.

At block 2310, processing circuitry 2602 determines a MDT configuration including an area scope. In some examples, the network node is a core network (“CN”) node and determining the MDT configuration includes transmitting the MDT configuration to a radio access network (“RAN”) node. In other examples, the network node is a RAN node and determining the MDT configuration includes receiving the MDT configuration from a second network node. The second network node can include at least one of: CN node in a PLMN; an OAM in a PLMN; a CN node in a SNPN; and an OAM in a SNPN.

In some embodiments, the area scope identifies at least one of: an identity of a PNI-NPN; an identity of SNPN; and an identity of a PLMN. In some examples, the identity of the PNI-NPN comprises a CAG. In additional or alternative examples, the identity of the SNPN includes a NID.

At block 2320, processing circuitry 2602 configures a communication device served by a first cell to collect MDT measurements from a second cell. In some embodiments, the first cell is associated with a first communications network and the second cell is associated with a second communications network. In some examples, the first communications network is a NPN and the second communication network includes at least one of: a PLMN; a SNPN; and a PNI-NPN. In other examples, the first communications network is a public network, and the second communication network includes at least one of: a SNPN; and a PNI-NPN.

In additional or alternative embodiments, the MDT configuration includes an indication that the communication device report collected MDT measurements as the MDT measurements are collected.

In additional or alternative embodiments, the MDT configuration includes an indication that the communication device log collected MDT measurements as the MDT measurements are collected.

In additional or alternative embodiments, configuring the communication device includes transmitting the MDT configuration as part of at least one of: an initial context setup request; a handover request; and a path switch request acknowledge.

In additional or alternative embodiments, the communication device is operating in dual connectivity. Configuring the communication device includes transmitting the MDT configuration for both a master node, MN, and a secondary node, SN, to at least one of the MN and the SN. In some examples, the first cell is operating in a public network as the MN and the second cell is operating in a NPN as the SN. In additional or alternative examples, the first cell is operating in a SNPN as the MN and the second cell is operating in a PNI-NPN as the SN.

At block 2330, processing circuitry 2602 receives, via communication interface 2606, the MDT measurements. In some embodiments, the MDT measurements are received from the communication device. In additional or alternative embodiments, the MDT measurements are received from the second communications device.

At block 2340, processing circuitry 2602 transmits, via communication interface 2606, the MDT measurements. In some embodiments, the MDT measurements are transmitted to the second communications network.

Various operations illustrated in FIG. 23 may be optional in respect to some embodiments.

FIG. 24 shows an example of a communication system 2400 in accordance with some embodiments.

In the example, the communication system 2400 includes a telecommunication network 2402 that includes an access network 2404, such as a radio access network (RAN), and a core network 2406, which includes one or more core network nodes 2408. The access network 2404 includes one or more access network nodes, such as network nodes 2410a and 2410b (one or more of which may be generally referred to as network nodes 2410), or any other similar 3^{rd} Generation Partnership Project (3GPP) access node or non-3GPP access point. Moreover, as will be appreciated by those of skill in the art, the network nodes 2410 are not necessarily limited to an implementation in which a radio portion and a baseband portion are supplied and integrated by a single vendor. Thus, it will be understood that the network nodes 2410 may include disaggregated implementations or portions thereof. For example, in some embodiments, the telecommunication network 2402 includes one or more Open-RAN (ORAN) network nodes. An ORAN network node is a node in the telecommunication network 2402 that supports an ORAN specification (e.g., a specification published by the O-RAN Alliance, or any similar organization) and may operate alone or together with other nodes to implement one or more functionalities of any node in the telecommunication network 2402, including one or more network nodes 2410 and/or core network nodes 2408.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 2410 facilitate direct or indirect connection of user equipment (UE), such as by connecting wireless devices 2412a, 2412b, 2412c, and 2412d (one or more of which may be generally referred to as UEs 2412) to the core network 2406 over one or more wireless connections. The network nodes 2410 facilitate direct or indirect connection of user equipment (UE), such as by connecting UEs 2412a, 2412b, 2412c, and 2412d (one or more of which may be generally referred to as UEs 2412) to the core network 2406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2400 may include any number of wired or wireless networks, network nodes, UEs, and/or any other components or systems that may facilitate or participate in the communication of data and/or signals whether via wired or wireless connections. The communication system 2400 may include and/or interface with any type of communication, telecommunication, data, cellular, radio network, and/or other similar type of system.

The UEs 2412 may be any of a wide variety of communication devices, including wireless devices arranged, configured, and/or operable to communicate wirelessly with the network nodes 2410 and other communication devices. Similarly, the network nodes 2410 are arranged, capable, configured, and/or operable to communicate directly or indirectly with the UEs 2412 and/or with other network nodes or equipment in the telecommunication network 2402 to enable and/or provide network access, such as wireless network access, and/or to perform other functions, such as administration in the telecommunication network 2402.

In the depicted example, the core network 2406 connects the network nodes 2410 to one or more hosts, such as host 2416. These connections may be direct or indirect via one or more intermediary networks or devices. In other examples, network nodes may be directly coupled to hosts. The core network 2406 includes one more core network nodes (e.g., core network node 2408) that are structured with hardware and software components. Features of these components may be substantially similar to those described with respect to the UEs, network nodes, and/or hosts, such that the descriptions thereof are generally applicable to the corresponding components of the core network node 2408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2416 may be under the ownership or control of a service provider other than an operator or provider of the access network 2404 and/or the telecommunication network 2402, and may be operated by the service provider or on behalf of the service provider. The host 2416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2400 of FIG. 24 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2402 is a cellular network that implements 3GPP standardized features. Accordingly, the telecommunications network 2402 may support network slicing to provide different logical networks to different devices that are connected to the telecommunication network 2402. For example, the telecommunications network 2402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2412 are configured to transmit and/or receive information without direct human interaction. For instance, a UE may be designed to transmit information to the access network 2404 on a predetermined schedule, when triggered by an internal or external event, or in response to requests from the access network 2404. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 2414 communicates with the access network 2404 to facilitate indirect communication between one or more UEs (e.g., UE 2412c and/or 2412d) and network nodes (e.g., network node 2410b). In some examples, the hub 2414 may be a controller, router, content source and analytics, or any of the other communication devices described herein regarding UEs. For example, the hub 2414 may be a broadband router enabling access to the core network 2406 for the UEs. As another example, the hub 2414 may be a controller that sends commands or instructions to one or more actuators in the UEs. Commands or instructions may be received from the UEs, network nodes 2410, or by executable code, script, process, or other instructions in the hub 2414. As another example, the hub 2414 may be a data collector that acts as temporary storage for UE data and, in some embodiments, may perform analysis or other processing of the data. As another example, the hub 2414 may be a content source. For example, for a UE that is a VR headset, display, loudspeaker or other media delivery device, the hub 2414 may retrieve VR assets, video, audio, or other media or data related to sensory information via a network node, which the hub 2414 then provides to the UE either directly, after performing local processing, and/or after adding additional local content. In still another example, the hub 2414 acts as a proxy server or orchestrator for the UEs, in particular in if one or more of the UEs are low energy IoT devices.

The hub 2414 may have a constant/persistent or intermittent connection to the network node 2410b. The hub 2414 may also allow for a different communication scheme and/or schedule between the hub 2414 and UEs (e.g., UE 2412c and/or 2412d), and between the hub 2414 and the core network 2406. In other examples, the hub 2414 is connected to the core network 2406 and/or one or more UEs via a wired connection. Moreover, the hub 2414 may be configured to connect to an M2M service provider over the access network 2404 and/or to another UE over a direct connection. In some scenarios, UEs may establish a wireless connection with the network nodes 2410 while still connected via the hub 2414 via a wired or wireless connection. In some embodiments, the hub 2414 may be a dedicated hub—that is, a hub whose primary function is to route communications to/from the UEs from/to the network node 2410b. In other embodiments, the hub 2414 may be a non-dedicated hub—that is, a device which is capable of operating to route communications between the UEs and network node 2410b, but which is additionally capable of operating as a communication start and/or end point for certain data channels.

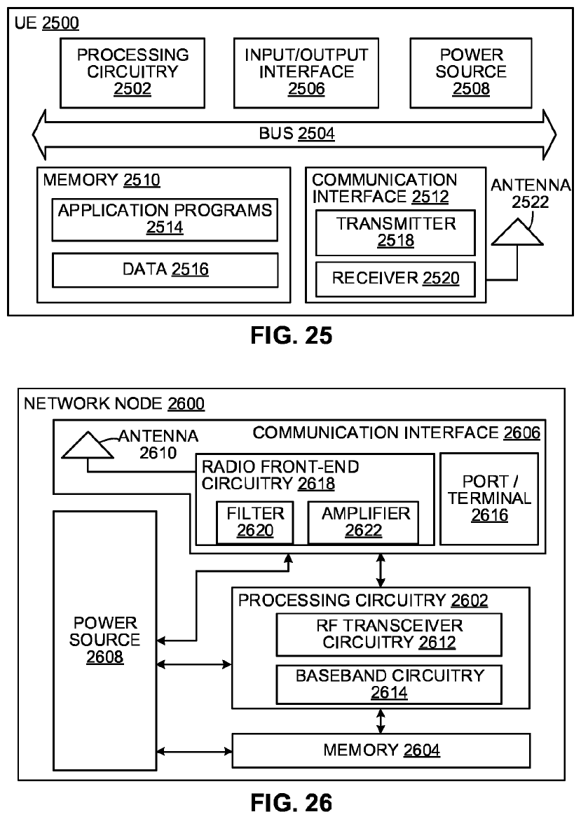

FIG. 25 shows a UE 2500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 2500 includes processing circuitry 2502 that is operatively coupled via a bus 2504 to an input/output interface 2506, a power source 2508, a memory 2510, a communication interface 2512, and/or any other component, or any combination thereof. Certain UEs may utilize all or a subset of the components shown in FIG. 25. The level of integration between the components may vary from one UE to another UE. Further, certain UEs may contain multiple instances of a component, such as multiple processors, memories, transceivers, transmitters, receivers, etc.

The processing circuitry 2502 is configured to process instructions and data and may be configured to implement any sequential state machine operative to execute instructions stored as machine-readable computer programs in the memory 2510. The processing circuitry 2502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2502 may include multiple central processing units (CPUs).

In the example, the input/output interface 2506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2508 is structured as a battery or battery pack. Other types of power sources, such as an external power source (e.g., an electricity outlet), photovoltaic device, or power cell, may be used. The power source 2508 may further include power circuitry for delivering power from the power source 2508 itself, and/or an external power source, to the various parts of the UE 2500 via input circuitry or an interface such as an electrical power cable. Delivering power may be, for example, for charging of the power source 2508. Power circuitry may perform any formatting, converting, or other modification to the power from the power source 2508 to make the power suitable for the respective components of the UE 2500 to which power is supplied.

The memory 2510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2510 includes one or more application programs 2514, such as an operating system, web browser application, a widget, gadget engine, or other application, and corresponding data 2516. The memory 2510 may store, for use by the UE 2500, any of a variety of various operating systems or combinations of operating systems.

The memory 2510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2510 may allow the UE 2500 to access instructions, application programs and the like, stored on transitory or non-transitory memory media, to off-load data, or to upload data. An article of manufacture, such as one utilizing a communication system may be tangibly embodied as or in the memory 2510, which may be or comprise a device-readable storage medium.

The processing circuitry 2502 may be configured to communicate with an access network or other network using the communication interface 2512. The communication interface 2512 may comprise one or more communication subsystems and may include or be communicatively coupled to an antenna 2522. The communication interface 2512 may include one or more transceivers used to communicate, such as by communicating with one or more remote transceivers of another device capable of wireless communication (e.g., another UE or a network node in an access network). Each transceiver may include a transmitter 2518 and/or a receiver 2520 appropriate to provide network communications (e.g., optical, electrical, frequency allocations, and so forth). Moreover, the transmitter 2518 and receiver 2520 may be coupled to one or more antennas (e.g., antenna 2522) and may share circuit components, software or firmware, or alternatively be implemented separately.

In the illustrated embodiment, communication functions of the communication interface 2512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2500 shown in FIG. 25.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 26 shows a network node 2600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2600 includes a processing circuitry 2602, a memory 2604, a communication interface 2606, and a power source 2608. The network node 2600 may be composed of multiple physically separate components (e.g., a NodeB component and a RNC component, or a BTS component and a BSC component, etc.), which may each have their own respective components. In certain scenarios in which the network node 2600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2600 may be configured to support multiple radio access technologies (RATs). In such embodiments, some components may be duplicated (e.g., separate memory 2604 for different RATs) and some components may be reused (e.g., a same antenna 2610 may be shared by different RATs). The network node 2600 may also include multiple sets of the various illustrated components for different wireless technologies integrated into network node 2600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2600.

The processing circuitry 2602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2600 components, such as the memory 2604, to provide network node 2600 functionality.

In some embodiments, the processing circuitry 2602 includes a system on a chip (SOC). In some embodiments, the processing circuitry 2602 includes one or more of radio frequency (RF) transceiver circuitry 2612 and baseband processing circuitry 2614. In some embodiments, the radio frequency (RF) transceiver circuitry 2612 and the baseband processing circuitry 2614 may be on separate chips (or sets of chips), boards, or units, such as radio units and digital units. In alternative embodiments, part or all of RF transceiver circuitry 2612 and baseband processing circuitry 2614 may be on the same chip or set of chips, boards, or units.

The memory 2604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2602. The memory 2604 may store any suitable instructions, data, or information, including a computer program, software, an application including one or more of logic, rules, code, tables, and/or other instructions capable of being executed by the processing circuitry 2602 and utilized by the network node 2600. The memory 2604 may be used to store any calculations made by the processing circuitry 2602 and/or any data received via the communication interface 2606. In some embodiments, the processing circuitry 2602 and memory 2604 is integrated.

The communication interface 2606 is used in wired or wireless communication of signaling and/or data between a network node, access network, and/or UE. As illustrated, the communication interface 2606 comprises port(s)/terminal(s) 2616 to send and receive data, for example to and from a network over a wired connection. The communication interface 2606 also includes radio front-end circuitry 2618 that may be coupled to, or in certain embodiments a part of, the antenna 2610. Radio front-end circuitry 2618 comprises filters 2620 and amplifiers 2622. The radio front-end circuitry 2618 may be connected to an antenna 2610 and processing circuitry 2602. The radio front-end circuitry may be configured to condition signals communicated between antenna 2610 and processing circuitry 2602. The radio front-end circuitry 2618 may receive digital data that is to be sent out to other network nodes or UEs via a wireless connection. The radio front-end circuitry 2618 may convert the digital data into a radio signal having the appropriate channel and bandwidth parameters using a combination of filters 2620 and/or amplifiers 2622. The radio signal may then be transmitted via the antenna 2610.

Similarly, when receiving data, the antenna 2610 may collect radio signals which are then converted into digital data by the radio front-end circuitry 2618. The digital data may be passed to the processing circuitry 2602. In other embodiments, the communication interface may comprise different components and/or different combinations of components.

In certain alternative embodiments, the network node 2600 does not include separate radio front-end circuitry 2618, instead, the processing circuitry 2602 includes radio front-end circuitry and is connected to the antenna 2610. Similarly, in some embodiments, all or some of the RF transceiver circuitry 2612 is part of the communication interface 2606. In still other embodiments, the communication interface 2606 includes one or more ports or terminals 2616, the radio front-end circuitry 2618, and the RF transceiver circuitry 2612, as part of a radio unit (not shown), and the communication interface 2606 communicates with the baseband processing circuitry 2614, which is part of a digital unit (not shown).

The antenna 2610 may include one or more antennas, or antenna arrays, configured to send and/or receive wireless signals. The antenna 2610 may be coupled to the radio front-end circuitry 2618 and may be any type of antenna capable of transmitting and receiving data and/or signals wirelessly. In certain embodiments, the antenna 2610 is separate from the network node 2600 and connectable to the network node 2600 through an interface or port.

The antenna 2610, communication interface 2606, and/or the processing circuitry 2602 may be configured to perform any receiving operations and/or certain obtaining operations described herein as being performed by the network node. Any information, data and/or signals may be received from a UE, another network node and/or any other network equipment.

Similarly, the antenna 2610, the communication interface 2606, and/or the processing circuitry 2602 may be configured to perform any transmitting operations described herein as being performed by the network node. Any information, data and/or signals may be transmitted to a UE, another network node and/or any other network equipment.

The power source 2608 provides power to the various components of network node 2600 in a form suitable for the respective components (e.g., at a voltage and current level needed for each respective component). The power source 2608 may further comprise, or be coupled to, power management circuitry to supply the components of the network node 2600 with power for performing the functionality described herein. For example, the network node 2600 may be connectable to an external power source (e.g., the power grid, an electricity outlet) via an input circuitry or interface such as an electrical cable, whereby the external power source supplies power to power circuitry of the power source 2608. As a further example, the power source 2608 may comprise a source of power in the form of a battery or battery pack which is connected to, or integrated in, power circuitry. The battery may provide backup power should the external power source fail.

Embodiments of the network node 2600 may include additional components beyond those shown in FIG. 26 for providing certain aspects of the network node's functionality, including any of the functionality described herein and/or any functionality necessary to support the subject matter described herein. For example, the network node 2600 may include user interface equipment to allow input of information into the network node 2600 and to allow output of information from the network node 2600. This may allow a user to perform diagnostic, maintenance, repair, and other administrative functions for the network node 2600.

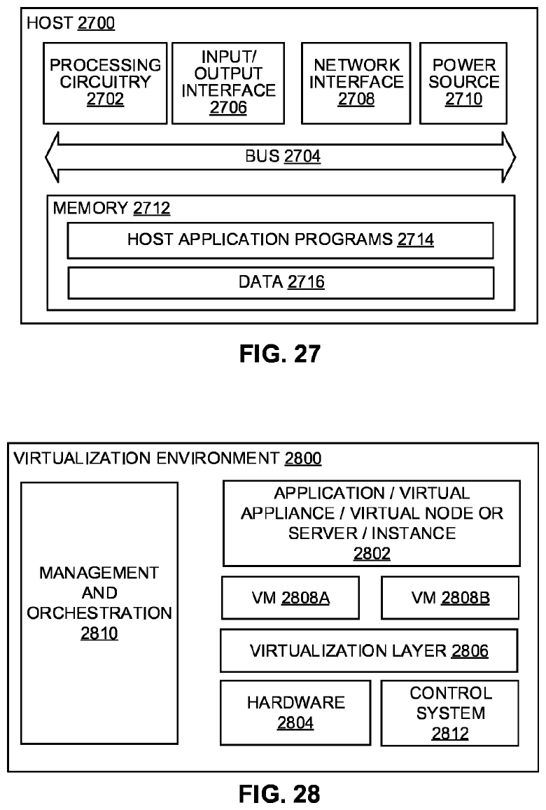

FIG. 27 is a block diagram of a host 2700, which may be an embodiment of the host 2416 of FIG. 24, in accordance with various aspects described herein. As used herein, the host 2700 may be or comprise various combinations hardware and/or software, including a standalone server, a blade server, a cloud-implemented server, a distributed server, a virtual machine, container, or processing resources in a server farm. The host 2700 may provide one or more services to one or more UEs.

The host 2700 includes processing circuitry 2702 that is operatively coupled via a bus 2704 to an input/output interface 2706, a network interface 2708, a power source 2710, and a memory 2712. Other components may be included in other embodiments. Features of these components may be substantially similar to those described with respect to the devices of previous figures, such as FIGS. 25 and 26, such that the descriptions thereof are generally applicable to the corresponding components of host 2700.

The memory 2712 may include one or more computer programs including one or more host application programs 2714 and data 2716, which may include user data, e.g., data generated by a UE for the host 2700 or data generated by the host 2700 for a UE. Embodiments of the host 2700 may utilize only a subset or all of the components shown. The host application programs 2714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2714 may also provide for user authentication and licensing checks and may periodically report health, routes, and content availability to a central node, such as a device in or on the edge of a core network. Accordingly, the host 2700 may select and/or indicate a different host for over-the-top services for a UE. The host application programs 2714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 28 is a block diagram illustrating a virtualization environment 2800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2800 includes components defined by the O-RAN Alliance, such as an O-Cloud environment orchestrated by a Service Management and Orchestration Framework via an O-2 interface.

Applications 2802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2806 (also referred to as hypervisors or virtual machine monitors (VMMs)), provide VMs 2808a and 2808b (one or more of which may be generally referred to as VMs 2808), and/or perform any of the functions, features and/or benefits described in relation with some embodiments described herein. The virtualization layer 2806 may present a virtual operating platform that appears like networking hardware to the VMs 2808.

The VMs 2808 comprise virtual processing, virtual memory, virtual networking or interface and virtual storage, and may be run by a corresponding virtualization layer 2806.

Different embodiments of the instance of a virtual appliance 2802 may be implemented on one or more of VMs 2808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2808 may be a software implementation of a physical machine that runs programs as if they were executing on a physical, non-virtualized machine.

Each of the VMs 2808, and that part of hardware 2804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2808 on top of the hardware 2804 and corresponds to the application 2802.

Hardware 2804 may be implemented in a standalone network node with generic or specific components. Hardware 2804 may implement some functions via virtualization.

Alternatively, hardware 2804 may be part of a larger cluster of hardware (e.g. such as in a data center or CPE) where many hardware nodes work together and are managed via management and orchestration 2810, which, among others, oversees lifecycle management of applications 2802. In some embodiments, hardware 2804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2812 which may alternatively be used for communication between hardware nodes and radio units.

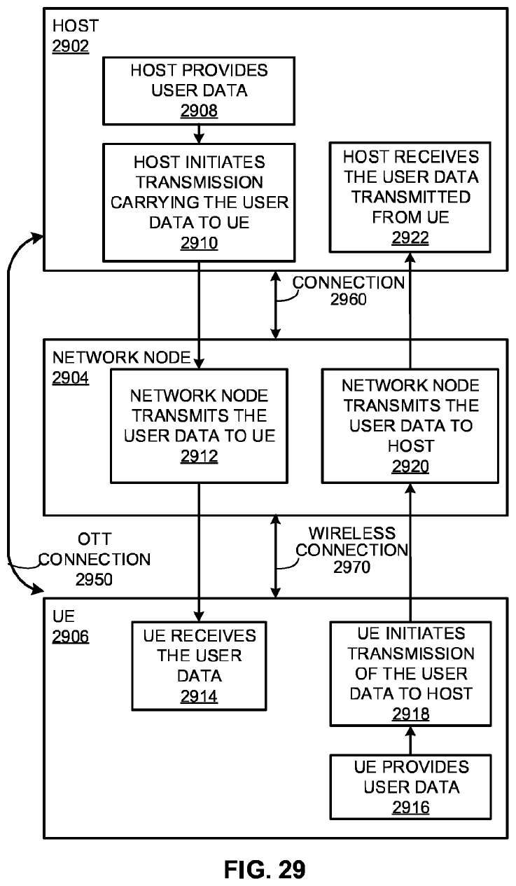

FIG. 29 shows a communication diagram of a host 2902 communicating via a network node 2904 with a UE 2906 over a partially wireless connection in accordance with some embodiments. Example implementations, in accordance with various embodiments, of the UE (such as a UE 2412a of FIG. 24 and/or UE 2500 of FIG. 25), network node (such as network node 2410a of FIG. 24 and/or network node 2600 of FIG. 26), and host (such as host 2416 of FIG. 24 and/or host 2700 of FIG. 27) discussed in the preceding paragraphs will now be described with reference to FIG. 29.

Like host 2700, embodiments of host 2902 include hardware, such as a communication interface, processing circuitry, and memory. The host 2902 also includes software, which is stored in or accessible by the host 2902 and executable by the processing circuitry. The software includes a host application that may be operable to provide a service to a remote user, such as the UE 2906 connecting via an over-the-top (OTT) connection 2950 extending between the UE 2906 and host 2902. In providing the service to the remote user, a host application may provide user data which is transmitted using the OTT connection 2950.

The network node 2904 includes hardware enabling it to communicate with the host 2902 and UE 2906. The connection 2960 may be direct or pass through a core network (like core network 2406 of FIG. 24) and/or one or more other intermediate networks, such as one or more public, private, or hosted networks. For example, an intermediate network may be a backbone network or the Internet.

The UE 2906 includes hardware and software, which is stored in or accessible by UE 2906 and executable by the UE's processing circuitry. The software includes a client application, such as a web browser or operator-specific “app” that may be operable to provide a service to a human or non-human user via UE 2906 with the support of the host 2902. In the host 2902, an executing host application may communicate with the executing client application via the OTT connection 2950 terminating at the UE 2906 and host 2902. In providing the service to the user, the UE's client application may receive request data from the host's host application and provide user data in response to the request data. The OTT connection 2950 may transfer both the request data and the user data. The UE's client application may interact with the user to generate the user data that it provides to the host application through the OTT connection 2950.

The OTT connection 2950 may extend via a connection 2960 between the host 2902 and the network node 2904 and via a wireless connection 2970 between the network node 2904 and the UE 2906 to provide the connection between the host 2902 and the UE 2906. The connection 2960 and wireless connection 2970, over which the OTT connection 2950 may be provided, have been drawn abstractly to illustrate the communication between the host 2902 and the UE 2906 via the network node 2904, without explicit reference to any intermediary devices and the precise routing of messages via these devices.

As an example of transmitting data via the OTT connection 2950, in step 2908, the host 2902 provides user data, which may be performed by executing a host application. In some embodiments, the user data is associated with a particular human user interacting with the UE 2906. In other embodiments, the user data is associated with a UE 2906 that shares data with the host 2902 without explicit human interaction. In step 2910, the host 2902 initiates a transmission carrying the user data towards the UE 2906. The host 2902 may initiate the transmission responsive to a request transmitted by the UE 2906. The request may be caused by human interaction with the UE 2906 or by operation of the client application executing on the UE 2906. The transmission may pass via the network node 2904, in accordance with the teachings of the embodiments described throughout this disclosure. Accordingly, in step 2912, the network node 2904 transmits to the UE 2906 the user data that was carried in the transmission that the host 2902 initiated, in accordance with the teachings of the embodiments described throughout this disclosure. In step 2914, the UE 2906 receives the user data carried in the transmission, which may be performed by a client application executed on the UE 2906 associated with the host application executed by the host 2902.

In some examples, the UE 2906 executes a client application which provides user data to the host 2902. The user data may be provided in reaction or response to the data received from the host 2902. Accordingly, in step 2916, the UE 2906 may provide user data, which may be performed by executing the client application. In providing the user data, the client application may further consider user input received from the user via an input/output interface of the UE 2906. Regardless of the specific manner in which the user data was provided, the UE 2906 initiates, in step 2918, transmission of the user data towards the host 2902 via the network node 2904. In step 2920, in accordance with the teachings of the embodiments described throughout this disclosure, the network node 2904 receives user data from the UE 2906 and initiates transmission of the received user data towards the host 2902. In step 2922, the host 2902 receives the user data carried in the transmission initiated by the UE 2906.

One or more of the various embodiments improve the performance of OTT services provided to the UE 2906 using the OTT connection 2950, in which the wireless connection 2970 forms the last segment. More precisely, the teachings of these embodiments may make it possible to report MDT measurements related information between SNPNs, PNI-NPNs and PLMNs which allows the networks to optimize the inter-network and intra-network coverage issues. It should be noted that the addition of the NPN identifiers in the list of networks where an MDT configuration is valid is not obvious. The reason this is not obvious is that private networks are separate networks with respect to PLMNs. As an example, SNPNs are not supposed to be connected to PLMNs or PNI NPNs. Further, a UE according to current specifications is not allowed to perform mobility between an SNPN and other networks different from the SNPN. Currently an MDT configuration can be applied to a UE only within a set of PLMNs that are equivalent with each other and that include the registered PLMN for the UE.

Hence the extension of the area scope of an MDT configuration to NPNs is not obvious because it implies coordination and agreements between the NPN operator and the PLMN operator. The advantages however of this configuration are that, for UEs that are able to move amongst NPNs and PLMNs, an operator (a PLMN or NPN operator) can configure MDT measurements at the UE and, by receiving such measurements, it is able to have a consistent monitoring of several aspects concerning the PLMN and the NPN, such as: (1) Monitoring of coverage at NPN and PLMN and at coverage borders between the PLMN and NPN. This allows to ensure that converge between the different networks is consistent and that mobility between different networks is not subject to failures due to poor coverage; and (2) Monitoring of performance at radio and service level for UEs moving between PLMNs and NPNs. This allows the operator to optimize the steering of UEs towards coverage locations where specific services are best served, as well as to optimize service coverage there where performance is poor.

In an example scenario, factory status information may be collected and analyzed by the host 2902. As another example, the host 2902 may process audio and video data which may have been retrieved from a UE for use in creating maps. As another example, the host 2902 may collect and analyze real-time data to assist in controlling vehicle congestion (e.g., controlling traffic lights). As another example, the host 2902 may store surveillance video uploaded by a UE. As another example, the host 2902 may store or control access to media content such as video, audio, VR or AR which it can broadcast, multicast or unicast to UEs. As other examples, the host 2902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2950 between the host 2902 and UE 2906, in response to variations in the measurement results. The measurement procedure and/or the network functionality for reconfiguring the OTT connection may be implemented in software and hardware of the host 2902 and/or UE 2906. In some embodiments, sensors (not shown) may be deployed in or in association with other devices through which the OTT connection 2950 passes; the sensors may participate in the measurement procedure by supplying values of the monitored quantities exemplified above, or supplying values of other physical quantities from which software may compute or estimate the monitored quantities. The reconfiguring of the OTT connection 2950 may include message format, retransmission settings, preferred routing etc. ; the reconfiguring need not directly alter the operation of the network node 2904. Such procedures and functionalities may be known and practiced in the art. In certain embodiments, measurements may involve proprietary UE signaling that facilitates measurements of throughput, propagation times, latency and the like, by the host 2902. The measurements may be implemented in that software causes messages to be transmitted, in particular empty or ‘dummy’ messages, using the OTT connection 2950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein.

Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a radio access network, RAN, node, the method comprising:
determining a minimization of drive tests, MDT, configuration including an area scope associated with cells that are identified by at least one of:
a public network integrated non-public network, PNI-NPN;
a standalone non-public network, SNPN; and
a public land mobile network, PLMN; and
configuring a communication device served by a first cell in a first communication network with the MDT configuration to instruct the communication device to collect MDT measurements from a second cell in a second communications network.

2. The method of claim 1, wherein the PNI-NPN are identified by a closed access group, CAG, and
wherein the SNPN are identified by a network identity, NID.

3. The method of claim 2, wherein the PNI-NPN are further identified by the PLMN and the CAG.

4. The method of claim 2, wherein the SNPN are further identified by the PLMN and the NID.

5. The method of claim 1, wherein the first communications network is a PNI-NPN, and
wherein the second communication network is the first communication network.

6. The method of claim 1, wherein the first communications network is a NPN, and
wherein the second communication network comprises at least one of:
a PLMN;
a SNPN; and
a PNI-NPN.

7. The method claim 1, wherein the first communications network is a public network, and
wherein the second communication network comprises at least one of:
a SNPN; and
a PNI-NPN.

8. The method of claim 1, wherein determining the MDT configuration comprises receiving the MDT configuration from a second network node comprising at least one of:
a core network, CN, node in a PLMN;
an operations, administration, and maintenance, OAM, in a PLMN;
a CN node in a SNPN; and
an OAM in a SNPN.

9. The method of claim 1, wherein the MDT configuration comprises an indication that a communication device report collected MDT measurements as the MDT measurements are collected.

10. The method of claim 1, wherein the MDT configuration comprises an indication that a communication device log collected MDT measurements as the MDT measurements are collected.

11. The method of laim 1, wherein configuring the communication device comprises transmitting the MDT configuration as part of at least one of:
an initial context setup request;
a handover request; and
a path switch request acknowledge.

12. The method of laim 1, wherein the communication device is operating in dual connectivity, and
wherein configuring the communication device comprises transmitting the MDT configuration for both a master node, MN, and a secondary node, SN, to at least one of the MN and the SN.

13. The method of claim 12, wherein the first cell is operating in a public network as the MN and the second cell is operating in a NPN as the SN.

14. The method of claim 12, wherein the first cell is operating in a SNPN as the MN and the second cell is operating in a PNI-NPN as the SN.

15. The method of claim 1, further comprising:
receiving the MDT measurements from the communication device.

16. The method of claim 15, further comprising:
transmitting the MDT measurements to the second communications network.

17. The method of claim 1, further comprising:
receiving the MDT measurements from the second communications network.

18. A method of operating a core network, CN, node, the method comprising:
transmitting a minimization of drive tests, MDT, configuration to a radio access network, RAN, node, the MDT configuration including an area scope that are identified by at least of:
a public network integrated non-public network, PNI-NPN;
a standalone non-public network, SNPN; and
a public land mobile network, PLMN.

19. A network node operating in a communications network, the network node comprising:
processing circuitry; and
memory coupled to the processing circuitry and having instructions stored therein that are executable by the processing circuitry to cause the network node to perform operations comprising the operations of claim 1.

20-21. (canceled)

22. A non-transitory computer-readable medium having instructions stored therein that are executable by processing circuitry of a network node operating in a communications network to cause the network node to perform operations comprising operations of claim 1.
